(19) United States
(12) Patent Application Publication
(10) Pub. No.: US 2021/0094201 A1
(43) Pub. Date: Apr. 1, 2021

(54) METHOD AND APPARATUS FOR CHOPPING FIBERS EMBEDDED WITHIN MATRIX RESIN

(71) Applicant: TRIUMPH AEROSTRUCTURES, LLC., Red Oak, TX (US)

(72) Inventors: Sean H. Finley, Spokane, WA (US); Jesse H. Newberry, Spokane, WA (US); Kyle Davis, Greenacres, WA (US)

(21) Appl. No.: 17/030,485

(22) Filed: Sep. 24, 2020

Related U.S. Application Data
(60) Provisional application No. 62/906,675, filed on Sep. 26, 2019.

(51) Int. Cl. B26D 9/00; B26D 1/24; B26D 1/22; B26D 7/26

(52) U.S. Cl. CPC B26D 9/00; B26D 7/2635; B26D 1/225; B26D 1/245

(57) ABSTRACT

A system for forming composite flake. An apparatus includes a first shearing assembly that meshes with a second shearing assembly to shear a length of composite material into a plurality of strips wherein reinforcing fibers of the composite material extend along the length of the composite strips. A chopping station receives the plurality of strips from the first and second shearing assemblies and shears the plurality strips across the axis of the reinforcing fibers to chop each strip into a plurality of pieces.

### RELATED APPLICATIONS

This application claims the benefit of priority of U.S. Provisional Application No. 62/906,675, filed on Sep. 26, 2019, the entire contents of which application(s) are incorporated herein by reference.

### FIELD OF THE INVENTION

The present invention relates to the field of composite materials. In particular, the present application relates to thermoplastic composite materials. More specifically, the present invention is directed toward a method and apparatus for forming chopping composite materials into flakes.

### BACKGROUND

Composite materials have been used in a wide variety of applications in which the benefit of low weight high strength materials outweigh the cost of the materials. For instance, historically, aerostructures have been formed of lightweight metals, such as aluminum and more recently titanium. However, a substantial portion of modern aircraft is formed from composite materials. A commonly used material in the aerospace industry is carbon fiber reinforced thermoplastic. One material commonly used is unidirectional carbon fiber reinforced thermoplastic tape. Such thermoplastic tapes have many advantages and are useful in a variety of applications. Although these reinforced thermoplastic tapes can be flexed or bent went heated, the tape remain quite rigid axially even when heated. Therefore, it may be difficult to form shapes that have tight bends or complex shapes. To overcome this limitation of reinforced thermoplastic tape, it may be desirable to use carbon fiber reinforced thermoplastic flake. The flake can be molded into complex geometries or tight curves more readily than tape. However, the process for producing carbon fiber reinforced thermoplastic flake can be inefficient and expensive. Accordingly, there is a need for a system for efficiently and rapidly forming carbon fiber reinforced thermoplastic flake.

### SUMMARY OF THE INVENTION

In view of the shortcomings of the prior art, according to one aspect, the present invention provides a method and apparatus for producing carbon fiber reinforced thermoplastic flake.

According to a first aspect, the present invention provides an apparatus for shearing a length of composite material having a plurality of reinforcing fibers into flakes of composite material. The apparatus may include a shearing station configured to shear the length of composite material into a plurality of elongated strips, wherein the shearing station is configured to shear the material substantially parallel with reinforcing fibers. The apparatus may further include a cutting station for cutting each of the strips of composite material into a plurality of pieces. The cutting station may be configured to cut the strips across the reinforcing fibers.

Optionally, the apparatus may include a storage station for storing a length of fiber reinforced composite material. The storage station may be configured to hold the material so that fibers of the material are parallel to a material path. Additionally, the shearing station may be positioned along the material path and the shearing station may be configured to shear the material in a direction that is parallel with the material direction.

The shearing station may be configured to receive the material from the storage station. Additionally, the shearing station may include a plurality of first shearing elements spaced apart from one another across the material path. The first shearing elements may be spaced apart from one another forming a plurality of gaps between adjacent shearing elements.

According to another aspect of the present invention, the shearing station may include a plurality of second shearing elements spaced apart from one another across the material path, wherein the second shearing elements are spaced apart from one another forming a plurality of gaps between adjacent shearing elements.

According to a further aspect of the present invention, each first shearing element is a rotary element having a first circumferential shearing surface, a second circumferential shearing surface and a circumferential support surface extending between the first circumferential shearing surface and the second circumferential shearing surface.

According to yet another aspect of the present invention, each second shearing element is a rotary element having a first circumferential shearing surface, a second circumferential shearing surface and a circumferential support surface extending between the first circumferential shearing surface and the second circumferential shearing surface.

According to a further aspect of the present invention, the apparatus includes a shearing assembly having first and second shearing elements that mesh so that the second shearing elements extend into gaps between adjacent first shearing elements and the first shearing elements extend into gaps between adjacent second shearing elements. Additionally, the first and second shearing elements may be configured to shear the material into a plurality of elongated strips parallel with the axis of the reinforcing fibers.

According to yet another aspect of the present invention a chopping station may be configured to receive strips of material from a shearing station. The chopping station may comprise a cutting element operable to cut each strip of material into a plurality of pieces. Additionally, the cutting element may be oriented transverse the material path to cut across the axis of the reinforcing fibers in the composite material.

While the methods and apparatus are described herein by way of example for several embodiments and illustrative drawings, those skilled in the art will recognize that the inventive methods and apparatus for sorting items using a dynamically reconfigurable sorting array are not limited to the embodiments or drawings described. It should be understood that the drawings and detailed description thereto are not intended to limit embodiments to the particular form disclosed. Rather, the intention is to cover all modifications, equivalents and alternatives falling within the spirit and scope of the methods and apparatus for sorting items using one or more dynamically reconfigurable sorting array defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

### DESCRIPTION OF THE DRAWINGS

The foregoing summary and the following detailed description of the preferred embodiments of the present invention will be best understood when read in conjunction with the appended drawings, in which:

FIG. 1 is a perspective view of a system for producing flake from fiber reinforced thermoplastic composite material;

FIG. 2 is a side view of the flake forming system illustrated in FIG. 1;

FIG. 3 is an enlarged perspective view of a spooling station of the flake forming system illustrated in FIG. 1;

FIG. 4 is an enlarged perspective view of a feed station of the flake forming system illustrated in FIG. 1;

FIG. 5 is an enlarged perspective view of a shearing station of the flake forming system of FIG. 1;

FIG. 6 is an enlarged plan view of a shearing assembly of the shearing station of FIG. 5;

FIG. 7 is a perspective view of the shearing assembly illustrated in FIG. 6;

FIG. 8 is an exploded perspective view of the shearing assembly illustrated in FIG. 7;

FIG. 9 is an enlarged fragmentary end view of the shearing assembly of FIG. 8 meshed with a second shearing assembly;

FIG. 10 is an enlarged fragmentary plan view of the shearing assembly illustrated in FIG. 8;

FIG. 11 is an enlarged perspective fragmentary view of the shearing assemblies illustrated in FIG. 9;

FIG. 12A is a perspective end view of the shearing assembly illustrated in FIG. 6;

FIG. 12B is a perspective end view of the shearing assembly illustrated in FIG. 12A showing the shearing assembly partially removed from the shearing station;

FIG. 12C is a perspective end view of the shearing assembly illustrated in FIG. 12B showing the shearing assembly removed from the shearing station;

FIG. 13 is a perspective view of a chopping station of the flake forming system illustrated in FIG. 1.

FIG. 14 is an enlarged fragmentary side view of the flake forming station illustrated in FIG. 13; and

FIG. 15 is an enlarged fragmentary side view of the flake forming station illustrated in FIG. 14.

### DETAILED DESCRIPTION OF THE INVENTION

Referring now to the figures in general, a system for forming flake material from reinforced composite material is designated generally 10. The system is configured to receive composite material, such as sheets of composite material or spools of composite material and cut the composite material into small shreds or flakes of material. The system may be used in conjunction with any of a variety of composite materials having a variety of reinforcing elements, such as glass strands or carbon fiber strands. Additionally, the composite material may incorporate any of a variety resins or matrix materials in which the fibers are embedded. For instance, the composite material may incorporate polymeric resins, such as thermoplastics or thermosets. Although the system 10 is operable with a variety of materials, the system is particularly suited to process carbon fibers reinforced thermoplastic material. Additionally, the system may process materials having reinforcing fibers that are oriented in any of a variety of patterns. For instance, the materials may have an overlapping, variable or random fiber direction meaning that the fiber direction varies along the length of the material and/or the reinforcing fibers overlap. However, as discussed below, the system 10 is particularly suited for processing composite material having unidirectional reinforcing fibers. In particular, the system 10 is configured to process lengths of carbon fiber reinforced thermoplastic material. The material may be any of a variety of widths. For instance, the width of the material may be as narrow as a few inches or as wide 12″ or wider. Accordingly, the system is not limited to include any particular composite material or any particular width of material. Therefore, in the following description, although the system 10 is described as processing carbon fiber tape, the term as used herein is defined broadly enough to include any system for chopping or cutting down fiber reinforced composite materials.

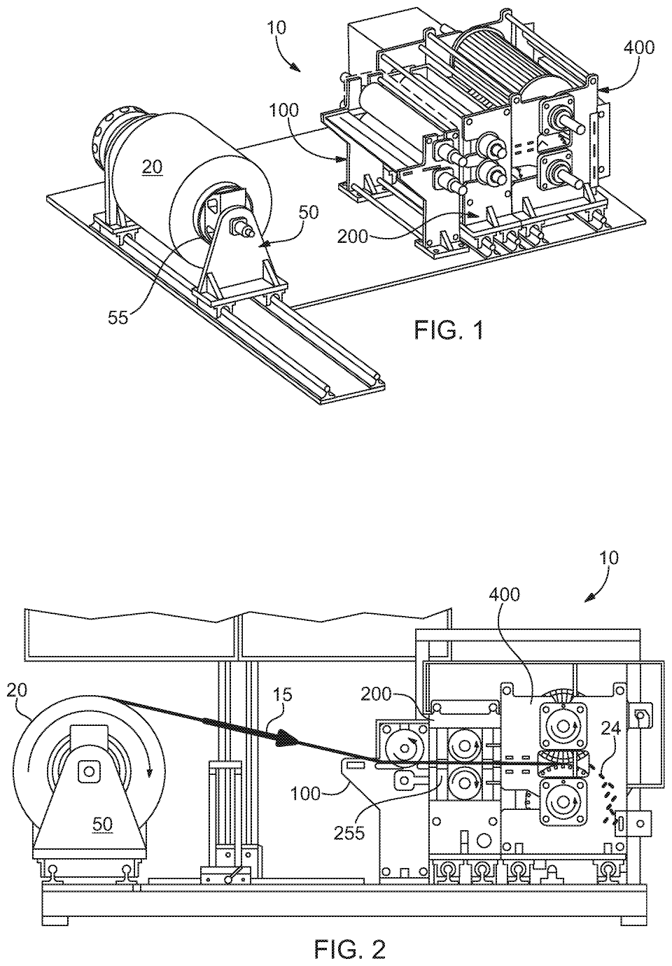

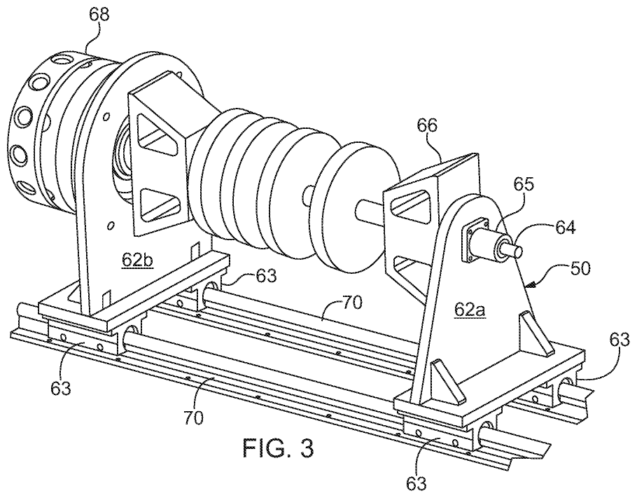

Referring to FIG. 1 a brief overview of the system 10 is provided. A supply of composite material is provided at a first end of the system 10. For example, an exemplary supply of material is shown as a spool 55 of unidirectional carbon fiber reinforced thermoplastic tape that is approximately 12″ wide. The tape is designated 20 and is loaded onto a tape storage module or spooling station 50. Referring to FIG. 2, the material follows a path through the machine that is designated 15. First, the material 20 is fed from the tape storage module 50 to a feed station 100 that controls the material at an entry nip between opposing rollers. From the feed station 100 the material 20 enters a shearing station 200 that shears the material into elongated thin strips of material. In the present instance, the shearing station is configured to shear the unidirectional tape in a direction parallel with the fiber direction so that the shearing station severs the strips of composite material without substantially cutting across the reinforcing fibers. From the shearing station 200 the strips of material are fed into a chopping station 400. At the chopping station the strips of material 22 are chopped in a direction transverse the direction the shearing station sheared the strips. For instance, in the present instance, the chopping station 400 chops the strips of material 22 across the fiber direction to chop the strips into short strips or flakes of material 24. The flake material 24 falls into a hopper or bin that collects the flake material.

As noted previously, the system 10 is operable in connection with a plurality of materials. However, the system 10 is particularly suited for forming composite flake from carbon fiber reinforced thermoplastic materials. Depending upon the application, the reinforcing elements may be any of a variety of reinforcing materials. By way of example, the reinforcing elements may be elongated strands or fibers of glass or carbon, however in the present instance the reinforcing elements are conductive materials, such as carbon fiber. For instance, an exemplary carbon fiber is a continuous, high strength, high strain, PAN based fiber in tows of 3,000 to 12,000. In particular, in the present instance, the reinforcing elements are carbon fibers produced by Hexcel Corporation of Stamford, Conn. and sold under the name HEXTOW, such as HEXTOW AS4D. However, it should be understood that these materials are intended as exemplary materials; other materials can be utilized depending on the environment in which the composite material is to be used.

The reinforcing elements are embedded within a matrix material, such as a polymer. Depending on the application, any of a variety of polymers can be used for the matrix material, including amorphous, crystalline and semi-crystalline polymers. In the present instance, the matrix material is a thermoplastic material, such as a thermoplastic elastomer. More specifically, the thermoplastic material is a semi-crystalline thermoplastic. In particular, the thermoplastic may be a thermoplastic polymer in the polyaryletherketone (PAEK) family, including, but not limited to polyetheretherketone (PEEK) and polyetherketoneketone (PEKK).

As noted above, the material processed by the system 10 may be carbon fiber reinforced thermoplastic composites. In particular, the material may be thermoplastic prepregs, which are laminae in which the reinforcement materials have been pre-impregnated with resin. For instance, the prepreg may be thermoplastic prepregs produced by coating reinforcement fibers with a thermoplastic matrix. Such a prepreg lamina has the ability to be reheated and reformed by heating the lamina above the melting point of the thermoplastic matrix. Several exemplary prepreg materials that may be used to form the structural elements 25, 26 include, but are not limited to, materials produced by TenCate Advanced Composites USA of Morgan Hill, Calif. and sold under the name CETEX, such as TC1200, TC1225 and TC1320. TC1200 is a carbon fiber reinforced semi-crystalline PEEK composite having a glass transition temperature (T_{g}) of 143° C./289° F. and a melting temperature (Tₘ) of 343° C./649° F. TC1225 is a carbon fiber reinforced semi-crystalline PAEK composite having a T_{g} of 147° C./297° F. and a Tₘ of 305° C./581° F. TC1320 is a carbon fiber reinforced semi-crystalline PEKK composite having a T_{g} of 150° C./318° F. and a Tₘ of 337° C./639° F.

In the following discussion, the composite material being processed by the machine 10 will be referred to as tape 20, which as discussed above includes any length of composite material regardless of the width of the material.

The system 10 includes a tape storage module 50 for storing a supply of tape 20 that is to be fed to the shearing and chopping stations 200, 400. For instance, the system 10 may include a reel or spool 55 and the tape 20 may be wound or coiled around the spool. Although the system is illustrated as including a single spool, it should be understood that the tape storing module 50 may include a plurality of storage elements for storing a plurality of spools of tape. It should be noted that the thickness of the tape 20 in the Figures is not to scale and in some instances the thickness is exaggerated for illustration purposes only.

The details of the different stations of the system 10 will now be described in greater detail. Referring to FIGS. 1-3, the system may include a storage module 50 for storing a length of tape 20, such as a length of tape coiled onto the cylindrical core of a spool 55. The tape 20 is a longitudinally elongated length of material having a pair of generally parallel edges. The tape may be a unidirectional tape so that the reinforcing fibers are generally parallel to the elongated edges. In this way, the spool has a central axis and the tape winds around the axis to form a coil. Therefore, the axis of the fibers in the tape is transverse the central axis of the spool 55. In this way, when tape is pulled or unwound from the spool the tape is pulled in a direction generally or substantially parallel to the axis of the reinforcing fibers.

The tape storage module 50 includes a stand 60 for supporting the spool with the central axis of the spool in a generally horizontal orientation. However, it should be understood that the system can be modified so that the spool 55 unwinds in a different orientation, such as an orientation in which the central axis of the spool is vertical. The stand 60 includes a pair of end supports 62a, 62b spaced apart from one another. A rotatable shaft 64 extends between the end support 62a, 62b. Additionally, a first journal bushing, such as a flanged sleeve bearing 65 may be attached to the first end support 62a and a second journal bushing may be attached to the second end support 62b. The shaft 64 may extend through the bushings 65 so that the bushings rotatably support the shaft. The spool 55 may have a hollow cylindrical core that is mounted on the shaft 64 so that the spool is rotatable around the axis of the shaft 64. The stand may further include a pair of centers 66 for supporting the ends of the spool. Specifically, each center includes a frustoconical or tapered surface that is insertable into the hollow core of the spool until the tapered surface engages the interior of the spool. In this way, the spool is supported at each end by one of the centers so that the spool is aligned parallel with the shaft 64. As discussed further below, the tape storage module 50 may also include a brake 68 operably connected with the shaft 64. The brake 68 is configured to resist rotation of the shaft 64. In this way, the brake 68 impedes rotation of the spool 55 to control feeding of the tape 20. Therefore, the brake 68 maintains tension on the roll of tape to impede the tape from uncoiling. Additionally, the brake 68 provides back tension during operation so that the brake tends to pull the tape back against the force of the system pulling the tape in the direction of the feed station 100.

The tape storage module 50 may also include an option mounting assembly that facilitates horizontal adjustment of the spool to align the spool with the feed station 100, shearing station 200 and chopping station 400. In the present instance, the tape storage module 50 may include a pair of elongated horizontal rails 70 that are spaced apart from one another. Each rail extends between the end supports 62a, 62b. Additionally, in the present instance, the rails 70 extend in a horizontal direction substantially parallel to the axis of rotation of the spool and transverse to the path 15 along with the tape travels through the feed station 100. A pair of guides 63 are attached to each of the end supports 62a, 62b. Each of the guides mate with the rails 70 so that the guides are slidable along the length of the rails. In the present instance, each guide 63 straddles the rail. The guides slide along the rail to position the horizontal location of the edges of the tape 20 on the spool 55. Additionally, the first end support 62a is displaceable relative to the second end support 62b to increase or decrease the distance between the end supports to accommodate various tape 20 widths. The stand 60 also includes a releasable lock, such as an over the center cam or an angled locking wedge that clamps one or more of the guides 63 against at least one of the rails 70 to lock the spool in place once the edges of the tape are aligned with the feed station 100.

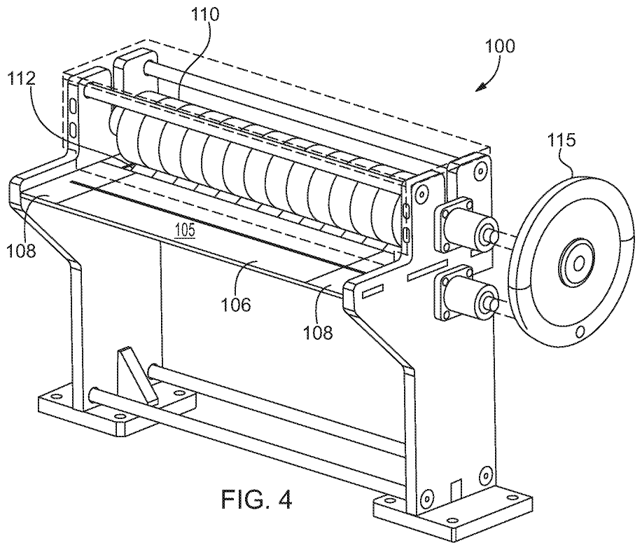

From the tape storage module 50 the tape 20 is fed to a feeding station 100. As shown in FIG. 4 the feed station 100 may include one or more rollers forming an entry nip configured to receive the tape 35 from the reel 42 and advance the tape toward the entry slot 255 of the shearing station 200. For instance, as shown in FIG. 2, the head 30 may include a pair or drive rollers 48 that form a nip and the tape may pass through the nipped drive rollers. The rollers are axially elongated rollers having an axis of rotation that is substantially parallel with the shaft of the tape storage module. Specifically, the feeder 100 includes an upper roller 110 that extends across the width of the material path and a lower roller 112 parallel and substantially similar to the upper roller. The outer surface of the rollers forms a generally high friction surface for frictionally engaging the material 20. The length of the rollers 110, 112 is at least as great as the width of the tape 20. The rollers 110, 112 are disposed adjacent one another so that the gap between the rollers is less than the thickness of the tape. Additionally, the rollers 110, 112 may be radially compressible so that the outer surface of the rollers compress as the tape passes between the rollers.

Upstream from the entry nip formed by the rollers 110, 112 an entry feed surface 105 forms a platform adjacent the rollers. The entry feed surface is a horizontal generally planar surface extending across the width of the material path. In the present instance, the entry feed surface 105 has a width that is wider than the width of the tape 20. Additionally, the entry feed surface 105 may include separate go and no-go areas. The no-go zone 106 extends across the central portion of the material path straddled between two go zones 108 that are spaced apart from one another, with one adjacent each end of the rollers 110, 112. The no-go and go zones 106, 108 may incorporate a visual indicator of whether the tape is tracking properly through the feeder. For instance, the no-go zone 106 may be colored a first color, such as red and the go zones 108 may be colored a second color, such as green. When the tape 20 is properly tracking through the feeder the tape may cover the red portion of the no-go zone so that only the green section of the go zone is visible. However, if the tape starts to wander or skew, the tape will move tranverse the material feed direction so that a portion of the red graphic of section 106 is visible to the operator. In this way, the graphic of the no-go zone 106 operates as a visual indicator that the tape is not tracking properly and/or has wandered from the center of the feeder.

The feed station 100 may also include a manual drive element for rotating at least one of the rollers 110, 112. As shown in FIG. 3, the upper roller is mounted on a shaft. A manual drive mechanism, such as a hand wheel 115 is connected with the shaft, so that rotating the hand wheel 115 rotates the shaft, which in turn rotates the upper roller 110. In this way, tape can be manually fed through the feed station by rotating the handwheel to feed tape through the roller 110, 112.

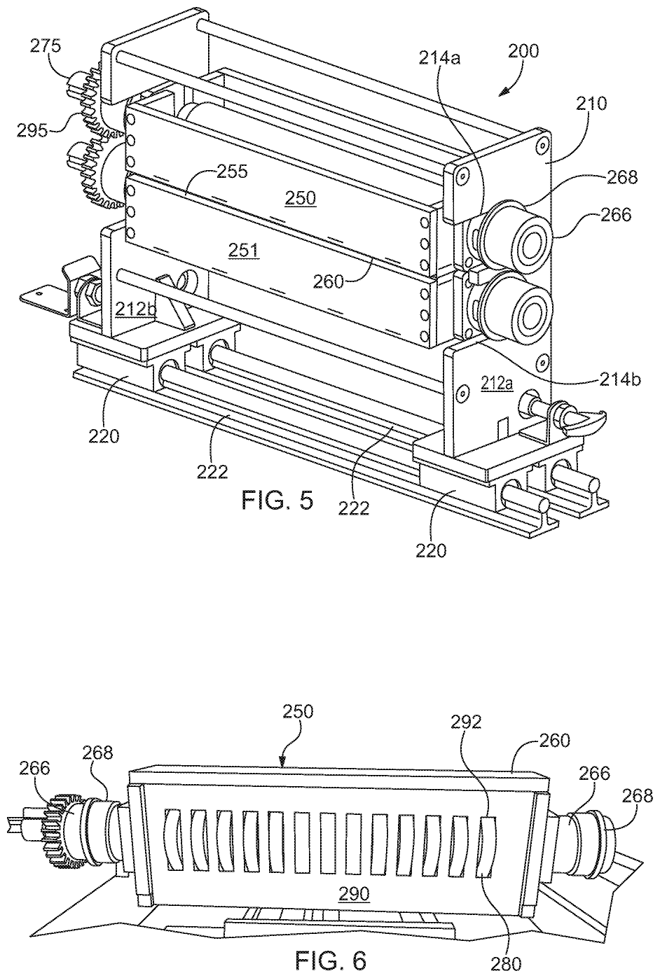

From the feed station 100, the tape 20 advances toward shearing station 200. Referring now to FIGS. 5-12, the shearing station 200 shears the tape 20 into a plurality of elongated slices 22 of the tape. The number of slices depends on the width of the tape and the width of each slice. The shearing station may be configured to slice the tape into a plurality of fixed or pre-set width slices. However, in the present instance, the configuration of the shearing station 200 may be re-configured as desired to slice the tape into a variety of widths. Specifically, the shearing station includes an adjustable shearing assembly that is configurable into a variety of shearing widths to slice the tape into a variety of widths. For instance, in a first configuration, the shearing station 200 may be configured to shear the tape into a plurality of slices having a width of 1/16″. For a 12″ tape, the shearing station shears the tape into 192 slices of tape that are each approximately 1/16″ wide. In a second configuration, the shearing station may be configured to shear the tape into a plurality of slices that are each ½″ wide. For a 12″ tape, the shearing station shears the tape into 24 slices of tape that are each approximately ½″ wide.

Referring to FIG. 5, the shearing station 200 includes a support stand 210 configured to support one or more shearing assemblies. In the present instance, the support stand 210 is configured to support an upper shearing assembly 250 and a lower shearing assembly 251. As described further below, the shearing assemblies are configured as cartridges that can be readily removed from the shearing station as an entire assembly. Accordingly, the upper shearing assembly is an upper cartridge 250 and the lower shearing assembly is a lower cartridge 251.

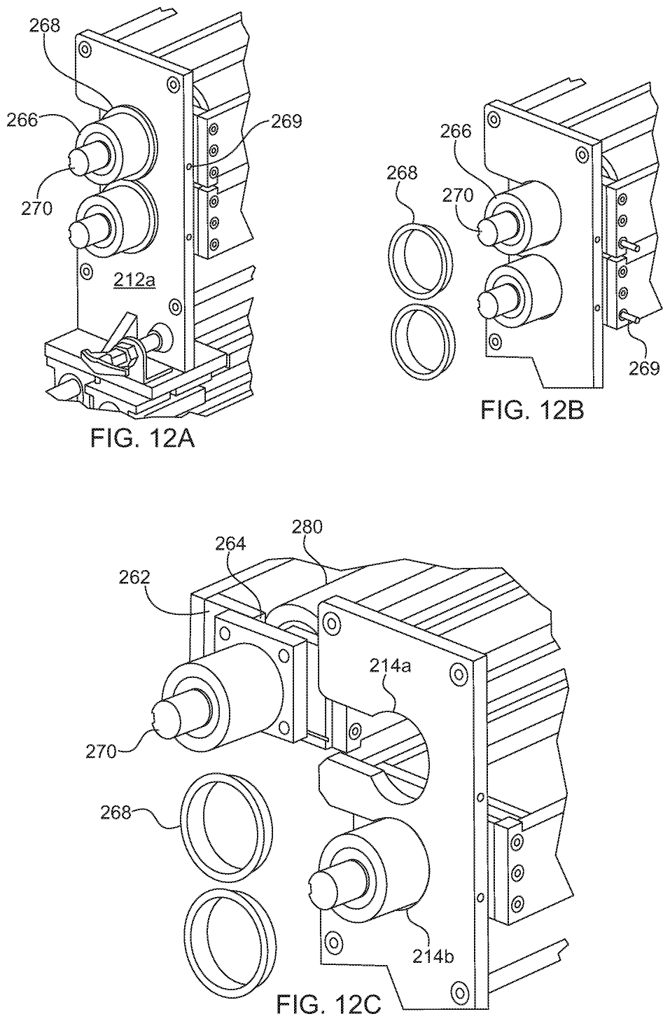

The support stand 210 is configured so that the shearing cartridges 250, 251 can be readily removed and replaced to facilitate both maintenance of the shearing assemblies and to allow the shearing assemblies to be reconfigured as necessary for different shearing widths. Accordingly, the support stand 210 includes a pair of substantially vertical end supports 212a, 212b. The end supports 212a, 212b are spaced apart from one another and a plurality of elongated rods interconnect the end supports to form a rigid and square frame, so that the first end support 212a is substantially parallel with the second end support 212b. Each end support 212a, 212b is configured to support an end of each of the shearing cartridges 250, 251. For instance, each end support may include a pair of mounting slots 214a, 214b. The slots may be keyhole shaped as shown in FIG. 12C and each upper keyhole slot 214a is configured to support an end of the upper cartridge 250 and the lower keyholes slots 214b are each configured to support an end of the lower cartridge 251.

The shearing station 200 may also be configured to provide precise alignment of the shearing cartridges 250, 251 with the material path 15 and the feed station 100. In particular, the shearing stand 210 includes guides 220 connected with the end supports 212a, 212b that cooperate with a pair of elongated rails 222. The rails extend across the material path, transverse the material path 15. The guides 220 and the rails 222 are configured substantially similarly to the guides 63 and the rails 70 described above in connection with the tape storage module 50 illustrated in FIG. 3.

The shearing cartridges 250, 251 are oriented transverse the material path so that the length of the shearing cartridges extends across the width of the material path. As discussed further below, the cartridges 250, 251 cooperate to shear the material 20 into a plurality of strips of material. The details for the lower shearing cartridge are the same as those for the upper shearing cartridge except as mentioned below. Accordingly, the details of the upper shearing assembly 250 will now be described in detail.

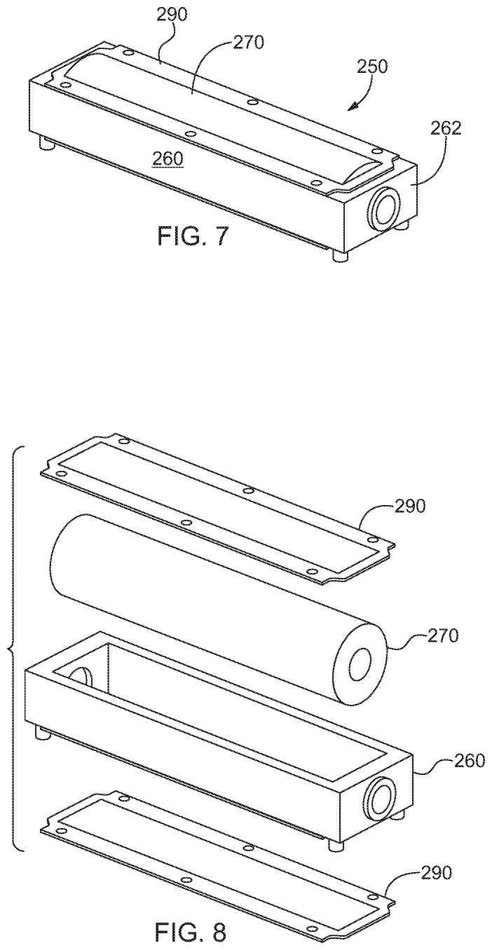

Referring to FIGS. 7-8, the upper cartridge 250 includes a shearer 270 for shearing the material. In the present instance, the shearer 270 is a rotary shearer that includes a cylindrical shearing disc 280. As shown in FIG. 10, the shearer 270 may include a stack of a plurality of shearing discs 280 mounted onto a shaft 275. The shearing discs 280 are coupled with the shaft so that rotation of the shaft 275 rotates the shearing discs. Specifically, the shearing discs 280 are rotationally fixed with the shaft 275. For instance, the shaft 275 and shearing discs 280 may include cooperable keyways that are interconnected by a key. The shearing discs 280 are spaced apart from one another to form gaps between adjacent shearing discs. In the present instance, the spacing between adjacent shearing discs is provided by a plurality of spacer discs. A spacer disc is positioned on the shaft 275 between adjacent shearing discs. The thickness of the spacer disc determines the gap between shearing discs. As discussed further below, in the present instance, the thickness of the spacer disc is substantially similar than the thickness of the shearing discs. Although each shearing disc 280 and each spacer disc 288 is illustrated as a single element, it should be understood that each shearing disc 280 and each spacer disc 288 may be formed of a plurality of narrower shearing discs or spacing abutting one another to form an equivalent width shearing disc or spacing disc. Accordingly, it should be understood that the term shearing disc or spacer disc includes a single integral element as shown in FIG. 10 or an equivalent disc formed of multiple elements.

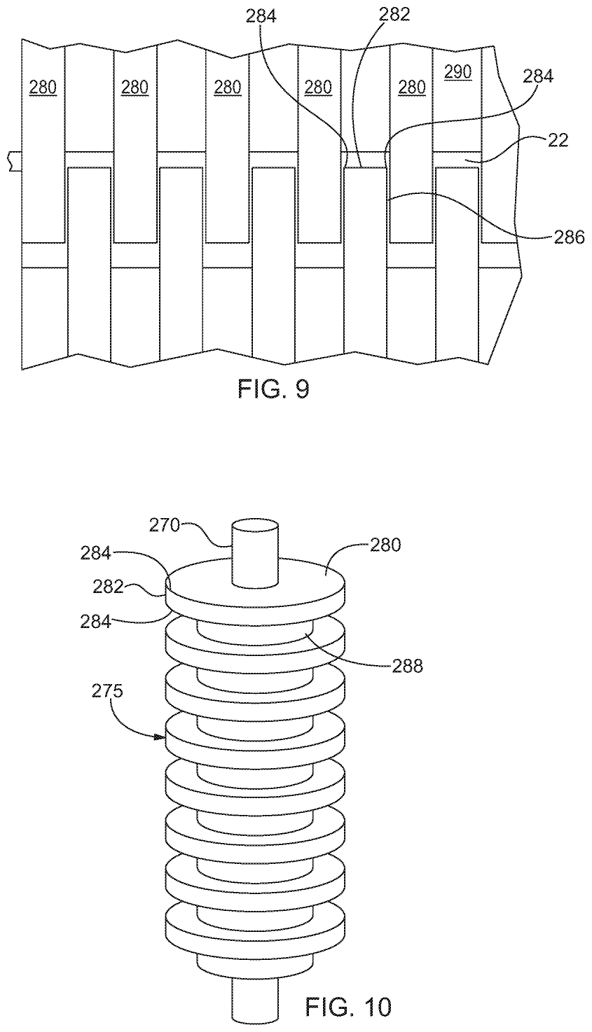

Each shearing disc 280 is a generally cylindrical element having a diameter that is significantly larger than its thickness. The outer periphery of the shearing disc includes a land 282 that forms a support surface 282 to support the composite material during the shearing process as discussed further below. The land 282 extends across substantially the entire thickness of the shearing disc 280 between two shearing edges 284. The shearing edges 284 are formed at the intersection of the land 282 with the side of the shearing disc. Specifically, each shearing edge 284 is a circumferential edge that extends around the periphery of the shearing disc. As shown in FIG. 9, the angle between the land 282 and the side of the shearing disc may be approximately 90 degrees. However, the angle between the land 282 and the side of the shearing disc may be less that 90 degrees so that the side forms a clearance or undercut for the shearing edge 284. Additionally, preferably, each shearing edge 284 forms a sharp edge rather than be curved or rounded.

As discussed below, the upper shearing cartridge 250 meshes with the lower shearing cartridge. Accordingly, the thickness of each shearing disc 280 and each spacer disc is configured to provide shearing surfaces and gaps that correspond with shearing surfaces and gaps of the opposing cartridge. In the present instance, the shearing stack 270 is configured so that each shearing disc 280 in the stack is substantially similar so that the thickness of each shearing disc in the stack has the same thickness. Similarly, each spacer 288 in the stack is substantially similar so that each spacer in the stack has substantially the same thickness. Additionally, the thickness of each spacer 288 is similar and corresponds with the thickness of each shearing disc 280. For instance, if each shearing disc has a thickness of ½″, the spacer discs have a thickness of ½″ plus a clearance tolerance. In this way, the gaps between adjacent shearing discs is greater than the thickness of the shearing discs.

Referring again to FIGS. 6-8, the shearing cartridge 250 includes a frame or holder 260 into which the shearing stack 270 is mounted. As shown in FIG. 8, the frame is a generally rectilinear frame having parallel front and rear sides connected by a pair of generally parallel ends 262. The shaft 275 of the shearing stack 270 extends through the ends 262. The cartridge may also include combing elements for combing the material from between the shearing discs as the shearing elements shear the material into strips. For instance, in the present instance, the cartridge 250 includes an upper comb and a lower comb 290. The combs 290 are covers that cover the upper and lower sides of the frame. Specifically, the comb 290 covers the gaps between shearing discs 280 and the edges of the frame 260 to deflect material away from the interior of the frame 260. As shown in FIG. 6, the comb 290 includes a plurality of windows positioned and configured to receive the shearing discs 280. In particular, the comb includes a plurality of rectangular apertures or windows having a width that is slightly larger than the width of the shearing discs and the windows are spaced apart from one another to align the windows with the shearing discs in the shearing stack. The comb 290 is positioned over the shearing stack 270 so that the shearing discs 280 project through the windows 292 of the comb 290 as shown in FIG. 6.

Configured as described above, the shearing cartridge 250 includes a plurality of spaced apart shearing elements with gaps formed between adjacent shearing elements. Each shearing element includes a pair of shearing edges spaced apart from one another and a support surface extends between the two shearing edges to support the material as the shearing elements shear the material. The lower shearing cartridge 250 is configured to mate or mesh with the upper shearing cartridge 251. In particular, the lower shearing cartridge includes a plurality of shearing elements configured and spaced apart from one another to fit into the gaps formed between adjacent shearing discs 280 in the shearing stack 270 of the upper cartridge 250. Similarly, the shearing elements of the lower cartridge are spaced apart to provide gaps configured and spaced apart to receive the shearing discs 280 of the upper cartridge. Although the shearing elements of the upper and lower cartridges need not be identical, in the present instance, the shearing elements of the lower cartridge are substantially the same thickness as the shearing elements of the upper cartridge and the gaps between the shearing discs of the lower cartridge is substantially the same as the gaps between the shearing discs of the upper cartridge.

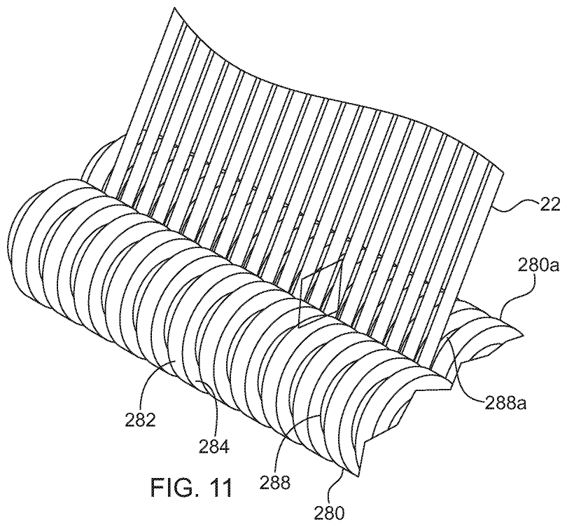

Referring now to FIGS. 9 and 11, the shearing discs 280 of the upper cartridge 250 mesh with the shearing discs 280a of the lower cartridge to form a plurality of overlapping shearing surfaces. Specifically, the shearing discs 280, 280a of the upper and lower cartridges 250, 251 are substantially identical. Similarly, the spacer discs 288, 288a of the upper and lower cartridges are substantially identical. However, the shearing discs and spacers of the upper cartridge are arranged in a mirror configuration of the shearing discs and spacers in the lower cartridge so that the shearing discs of the upper cartridge project into the gaps between the shearing discs of the lower cartridge and the shearing discs of the lower cartridge project into the gaps between the shearing discs of the upper cartridge.

As discussed previously, the spacers 288 have a thickness that is equal to the thickness of the shearing discs plus a clearance tolerance. In this way, a clearance gap 286 is formed between the overlapping sides of the shearing discs of the upper and lower cartridge as shown in FIG. 9. The clearance gap 286 allows the meshed shearing discs to rotate relative to one another. Additionally, the clearance gap 286 forms the shear line along which the composite tape is sheared to form a separate strip.

As shown in FIG. 5, a gap 255 is formed between the upper and lower cartridges 250, 251. The gap 255 forms a feed slot or entry slot for the composite tape 20. The tape is fed through the slot and toward the meshed shearing discs of the upper and lower cartridges. The opposing shearing stacks 270 of the upper and lower cartridges 250, 251 form a tapered entrance leading into the meshed shearing discs. Specifically, the periphery of the shearing discs form overlapping surfaces similar to rollers of a roller nip. As shown in FIG. 2, after first passing through the entry slot 255 material passes between the upper shearing discs and the lower shearing discs. Adjacent the entry slot 255, the outer periphery of the upper shearing discs is spaced apart from the outer periphery of the lower shearing discs as shown in FIG. 2. However, the distance between the outer periphery of the upper shearing discs and the lower shearing discs tapers down to zero as shown in FIG. 2. In this way, the shearing discs provide a tapered entrance that guides the material toward the interface of the shearing discs where the material is sheared. Referring again to FIG. 9, the overlapping shearing discs 280 shear the material along a line parallel with edges of the material to form a plurality of strips 22. Specifically, the upper shearing discs 280 force the tape downwardly into the gaps between the lower shearing discs. The lands 282 of the upper shearing discs provide support surfaces supporting the composite material as the material is forced into the gaps in the lower cartridge. At the same time, the shearing edges 284 of the lower shearing elements shearing the material into a plurality of strips. As shown in FIG. 9, the upper shearing elements force portions of the composite material downwardly toward the lower shearing elements to form a plurality of strips between the lower shearing elements. Similarly, the lower shearing discs force the composite material upwardly into the gaps between the upper shearing discs to form a plurality of strips 22 between the upper shearing discs.

As described above, the upper and lower shearing elements are configured to shear the composite tape rather than cut the tape. Specifically, the shearing station shears the tape along a plurality of shear lines by incorporating two opposing elements. The first element forces the tape against a shearing edge of the second element. The force of the first element against the second element causes the composite material to fracture along the shear line. Specifically, the tape is fractured along shear lines that are generally parallel with the elongated fibers of the material so that the shearing process shears the material into a plurality of strips while cutting across or fracturing a very small percentage of the reinforcing fibers.

The composite tape 20 is driven or pulled between the upper shearing cartridge 250 and the lower shearing cartridge 251 and the overlapping shearing surfaces of the two shearing cartridges shear the tape into a plurality of continuous strips as shown in FIG. 11. The upper and lower shearing cartridges 250, 251 are driven synchronously. Specifically, a gear 295 mounted on the shaft 275 of the upper cartridge 250 meshes with a gear mounted on the shaft of the lower cartridge 251. The gears on the upper and lower shafts are substantially similar to provide a one to one synchronous drive between the upper and lower cartridge. Additionally, as shown in FIG. 2, the gears interconnect the upper and lower cartridges so that the shearing disc rotate in opposing directions to pull the material downstream toward the meshed shearing discs. Specifically, the upper shearing discs rotate counter-clockwise from the perspective of FIG. 2 and the lower shearing discs rotate clockwise from the perspective of FIG. 2. In this way, a motor synchronously drives both cartridge assemblies. The motor may be directly coupled with one of the shafts 275 of the shearing cartridges or one or more intermediate element, such as one or more gears, may connect one of the shafts with the motor to drive the shearing cartridges.

As noted previously, the shearing station 200 may be configured so that the shearing elements may be readily replaced. Referring now to FIGS. 6 and 12A-C, the structure of the station that facilitates changing the shearing cartridges will be described in greater detail. The ends 262 of each frame 260 comprise a slot 264. The shaft 275 extends through the slot 264 and is journaled into an element that provides rotary support for the shaft. For instance, as shown in FIG. 12A the end of the shaft may be journaled in a journal bushing, such as a flanged sleeve bearing. The end supports 212a,b are configured to receive and support the journal bushings 275 attached to the shaft 275. Specifically, as Shown in FIG. 12C, the end supports include a pair of keyhole slots 214a,b. The upper keyhole slot 214a receives and supports a first end of the shaft of the upper cartridge and the lower keyhole slot 214b receives and supports a first end of the shaft of the lower cartridge. The slot of the keyhole slot 214a,b has a width that is wider that outer diameter of the journal bushing 264 so that the journal bushing can slide through the slot of the keyhole slot. A locking collar 268 circumscribes the journal bushing to lock the journal bushing in the keyhole of the keyhole slot 214a,b. Specifically, the locking collar comprises a flanged bushing having an internal diameter similar to the outer diameter of the journal bearing so that the locking collar fits over the journal bearing. The body of the locking collar has a first diameter that is larger than the width of the slot of the keyhole slot but smaller than the diameter of the keyhole so that the body of the locking collar projects through the keyhole while preventing the journal bearing from sliding through the slot of the keyhole. The locking collar also includes a circumferential flange having an outer diameter larger than the diameter of the keyhole so that the head of the flange abuts the face of the end support as shown in FIG. 12C. A locking element locks the locking collar with the end frame and with the journal bushing. For instance, the threaded hole may extend through the end support 212a and into the keyhole slot. A locking element, such as a set screw may extend through the threaded hole to lock down the locking collar. Additionally, the locking collar may include an opening or slot that aligns with the set screw so that the set screw extends through the locking collar to engage the outer surface of the journal bushing.

In this way, the cartridge may be removed from the shearing station as follows. First, the set screws 289 are unscrewed to disengage the set screws from the locking collar 268 and the journal bearing 266. The locking collar is then pulled out over the journal bushing 266 as shown in FIG. 12B. After the locking collar is removed the journal bushing slides through the slot of the keyhole slot 214a to remove the end of the upper cartridge 250 from the end support as shown in FIG. 12C. Once both ends of the cartridge are removed the shearing stack 270 can be lifted off the frame. The shearing stack 275 may include a pair of locking collars that lock the shearing discs and spacer discs on the shaft. To replace some or all of the shearing discs or spacer discs one or both of the locking collars may be removed from the shaft and the shearing disc(s) can be slid off the shaft. Similarly, to mount a shearing disc or spacer disc the disc(s) are slid onto the shaft in the desired order and orientation to create a shearing stack 270. The locking collars are then locked to fix the shearing discs and spacer discs in the desired order and orientation.

As discussed above, the shearing station is configured to shear the composite tape 20 into a plurality of parallel strips 22 as shown in FIG. 11. The strips exit the shearing station and enter the chopping station 400. The chopping station chops each of the strips into a plurality of pieces referred to as flake.

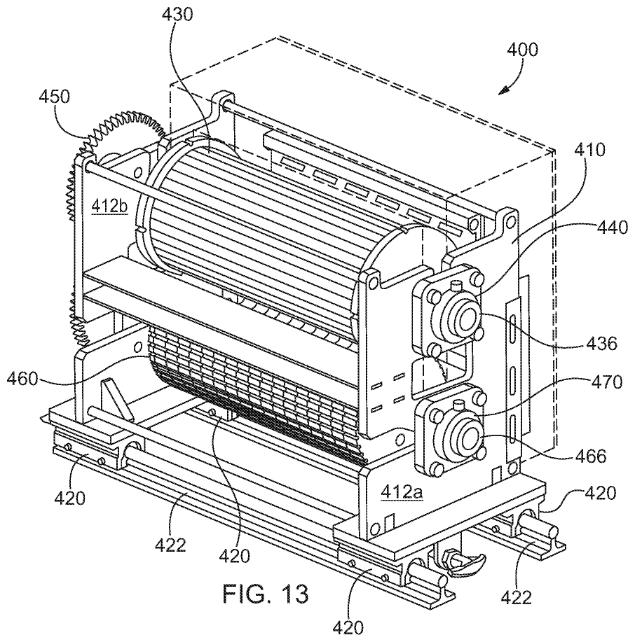

Referring now to FIGS. 13-15 the details of the chopping station 400 will be described in greater detail. The chopping station 400 extends across the width of the material path so that the chopping station receives all of the strips 22 as the strips exit the shearing station 200. The chopping station may include any of a variety of elements for cutting or shearing the strips of material into flake. For instance, the cutting station may include one or more knives or blades that chop the strips across the width of the strips to chops the strips into flake. An exemplary chopping station illustrated in FIG. 13 includes a rotary chopping drum that cooperates with a rotary die to chop the strips 22 into flake. The chopping station includes a support stand for supporting the cutting drum 430 and rotary die 460. The stand includes a pair of vertical end supports 412a, 412b that supports the ends of the cutting drum and the rotary die 460. A plurality of rods interconnect the end supports 412a, 412b to maintain the end supports aligned and square to one another.

Additionally, the stand may include one or more positioning elements for aligning the chopping station with the material path. More specifically, the positioning elements may allow for precise adjustment of the chopping station across the width of the material path. For instance, the chopping station may include a plurality of guides 420 attached to the bottom of the end supports 412a, 412b that cooperate with a pair of rails 422 that extends transverse the material path. The guides and rails are configured similar to and operate similar to the guides 63 and rails 70 described above in connection with the tape storage module 50.

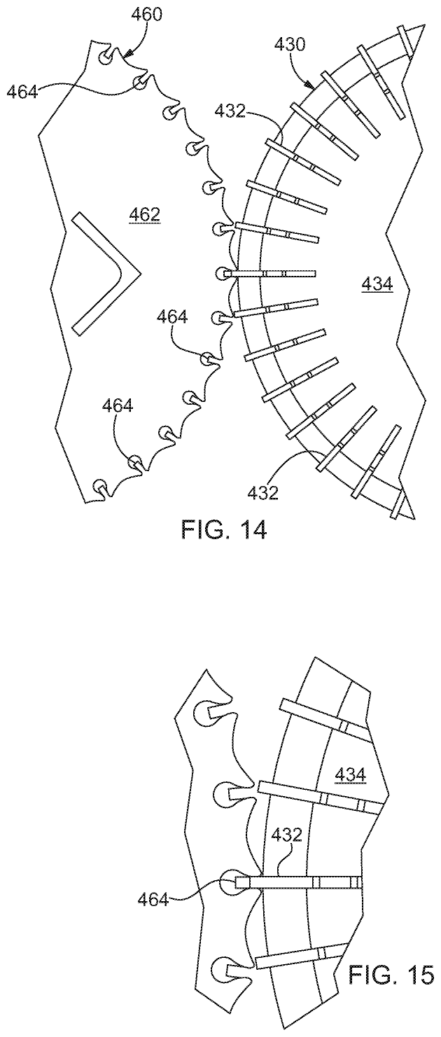

Referring to FIGS. 14-15, the chopping drum 430 has a plurality of chopping blades 432 mounted in a drum 434 that rotates about an axis transverse the material path. The chopping blades extend across the material path so that each blade is long enough to sever all of the strips 22 exiting the shearing station without overlapping the strips. Specifically, the chopping blades 430 each have a width that is greater than the width of the composite tape 20. The blades 432 are circumferentially spaced about the periphery of the drum 434 so that the cutting blades project radially outwardly away from the drum. The circumferential spacing between the blades correlates with the length of material chopped from the strips when the blades cut the strips into flake.

The cutting drum is rotationally mounted on a shaft 436 as shown in FIG. 13. Each end of the shaft 436 is journaled in a journal bearing 440 mounted on each end support 412a, 412b.

The rotary die 460 extends across the width of the material path and opposes the cutting drum 430. The rotary die 460 includes a cylindrical drum 462 having a plurality of cavities 464 spaced around the periphery of the drum. Each cavity extends along the width of the drum as shown in FIG. 13. As shown in FIG. 15, each cavity is an elongated slot having a width that is similar to the thickness of each cutting blade. In this way, the cavities 464 are configured to operate as die openings that cooperate with the cutting blades 432 to shear the material across the fiber direction to form flakes 24. Specifically, the opening of each cavity 464 comprises two shearing edges. The cutting blades 432 project into the cavity between the shearing edges. In this way, the cutting blades 432 drive the composite strips toward the rotary die 460 and the material shears at the edge of the cavity as the cutting blade projects into the cavity.

As shown in FIGS. 13-15, the rotary die has a diameter that is similar to the diameter of the rotary drum and the cavities 464 are circumferentially spaced around the periphery of the drum 462 similar to the circumferential spacing of the cutting blades 432 around the periphery of the cutting drum 432. In this way, the cavities 462 align with the cutting blades 430 as the rotary die 460 and chopping drum rotate.

The drum 462 of the rotary die is rotationally mounted on a shaft 466 as shown in FIG. 13. Each end of the shaft 466 is journaled in a journal bearing 470 mounted on each end support 412a, 412b.

A motor drives the chopping drum 430 and rotary die synchronously so that the cutting blades 432 align with the cavities 464. For instance, a first gear 450 may be mounted on the shaft 436 of the chopping drum. A second gear substantially similar to the first gear 450 may be mounted on the shaft 466 of the rotary die 460. The first and second gears may mesh to synchronize rotation of the two shafts. In this way, a single motor may synchronously drive both the rotary die and the chopping drum 430. The motor may be a separate motor that only drives the chopping drum and the rotary die. Alternatively, the motor that drives the shearing discs 280 of the shearing station may be configured to also drive the chopping drum and the rotary die.

As the chopping drum chops the strips into flake 24, the flake tends to fall downwardly away from the cutting blades 432. A bin or hopper may be placed below the interface of the chopping drum and the rotary die so that the flake falls into the drum. However, the flake may tend to adhere to the chopping blades. Accordingly, the chopping station 400 may include one or more nozzles providing one or more streams of air directed toward the cutting blades to blow the flake 24 away from the cutting blades so that the flake falls into the bin.

Configured as described above, the system 10 is configured to provide a continuous stream of flake material 24 having a uniform width and uniform length. In particular, by shearing the material along the length of the fibers using opposing shearing and supporting elements, the system is configured to produce strips of material having a uniform width. For instance, as described above, the shearing station is configured to maintain a tolerance of less than approximately 33% variance in width along the length of the strip. Further still, the shearing station may maintain a tolerance of less than approximately 10% variance along the length of the strip. For example, for strips 22 having a nominal width of ½″, the shearing station may maintain a tolerance of less than +/−0.060″ width variation along the length of the strip. For strips 22 having a width of 1/16″, the shearing station may maintain a tolerance of less than +/−0.020″ width variation. Similarly, the configuration of the chopping station provides a shearing action that is configured to chop the strips 22 to provide flakes 24 having a uniform length. For instance, as described above, the chopping station is configured to maintain a tolerance of less than 33% variance in length. Further still, preferably the chopping station is configured to maintain a tolerance of less than approximately 10% variance in length. For example, for flakes having a nominal length of ½″, the chopping station may maintain a tolerance of less than +/−0.060″ variation in length.

Method of Forming Flake

The details of forming reinforced thermoplastic flake will now be described. Referring to FIG. 1, a spool of material is mounted onto the tape storage module. The tape may be selected to have any of a number of desired characteristics. For instance, in one method, a composite tape is selected having carbon fiber reinforcing fibers embedded within a thermoplastic matrix. The tape may be a unidirectional tape so that the reinforcing fibers are aligned. The tape may be an elongated length of material with the unidirectional fibers aligned with the length of the material.

The selected spool 55 of tape is mounted on the by sliding the core of the spool 55 over the shaft 64 so that the tapered centers 66 engage the ends of the core of the spool. The end of the shaft 64 is aligned with the journal bushing 65 and the end support 62a is displaced toward the second end support 62b to wedge the spool between the centers 66. The spool is then displaced along the rails to center the tape with the go zone 106 on the entry surface 105 of the feed station. Once the spool is aligned with the material path 15, the guides 63 are locked in place on the rails 70 to lock the spool horizontally relative to the material path.

One the spool is mounted and locked in place, the free end or leading end of the coil of tape is pulled from the spool and fed into the feed station 100. In the present instance, the tape is oriented so that the reinforcing fibers are aligned with the material path so that pulling the tape off the spool pulls the tape along the axis of the reinforcing fibers. Additionally, as discussed above, the tape storage module 50 may include a brake 68 that impedes rotation of the spools 55. Specifically, the spool is frictionally engaged by the tapered centers 66 so that the spool does not rotate relative to the centers. The centers are connected with the shaft so that the centers rotate with the shaft. In this way, spool is rotationally coupled with the shaft 64. Since the brake 68 applies a braking force to the shaft 64, the brake applies a braking force that resists pulling the tape from the spool. To pull the tape from the spool, the operator pulls the tape with a force sufficient to overcome the braking force of the brake.

After pulling the leading edge of the tape from the spool, the tape fed onto the entry surface 105 of the feed station. Specifically, the leading edge of the tape is aligned with the go zone 106 so that the tape does not overlap either of the no-go zone 108. Once aligned with the go zone, the leading edge is inserted into the nip between the upper and lower feed roller 110, 112. The tape may be pushed through the feed nip to feed the tape through the feed station. Alternatively, once the leading edge of the tape is inserted into the feed nip the tape can be fed through the feed station by rotating hand wheel 115. Turning the hand wheel counterclockwise (from the perspective of FIG. 2) rotates the upper feed roller 110. The upper roller 110 frictionally engages the tape 20 pulling the tape off the spool against the braking force of the brake 68. At the same time, the braking force of the brake applies a biasing force in a direction opposite the material path to retain tension in the length of tape.

From the feed station 100, the tape is fed along the material path into the feed slot 255 of the shearing station 200. The leading edge of the tape 20 passes through the entry slot 255 and is fed toward the meshed shearing elements of the shearing station 200. The outer surface of the shearing elements guides the leading edge toward the point where the shearing elements mesh. The rotating shearing elements pulls the tape into the meshed interface between the shearing elements to shear the tape along an axis parallel to the reinforcing fibers in the tape.

As described above, the shearing elements may be rotary shearing elements and the shearing station may include a plurality of upper shearing elements and a plurality of lower shearing elements. The method may include the step of rotating the upper and lower shearing elements in opposite directions to pull the tape along the material path. The step of rotating the upper and lower shearing elements may include the step of driving the tape between the upper and lower shearing elements so that the upper shearing elements displace the tape downwardly to shearing edges on the lower shearing elements to shear the tape into a plurality of strips of composite material. Additionally, the lower shearing elements may displace the material upwardly toward shearing edges on the upper shearing elements to shear tape into a plurality of strips of composite material.

The method may also include the step of deflecting the strips away from the upper and lower shearing assemblies after the step of shearing the tape. Specifically, the upper and lower shearing assemblies may include a plurality of gaps between adjacent shearing elements and the step of deflecting the strips may include the step of deflecting the strips away from the gaps. Specifically, the step of deflecting may include the step of positioning a comb in the gaps to deflect the strips after the strips are sheared.

After the step of shearing the tape into strips, the method may include the step of chopping the strips into flakes. For instance, the method may include the step of conveying the strips of material from the shearing station to a chopping station so that the strips are side by side without overlapping. At the chopping station, the method may include the step of cutting the plurality of strips across the elongated axis of each strip so that each strip is cut into a plurality of flakes. The step of cutting may include the step of cutting the strips with a cutting blade having a length sufficient to extend across the width of all of the plurality of strips exiting the shearing station without the strips overlapping.

The method may also include the step of collecting the plurality of flakes into a collection bin.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

1. An apparatus for shearing fiber reinforced composite material, comprising:
a storage station for storing a length of fiber reinforced composite material, wherein the storage station is configured to hold the material so that fibers of the material are parallel to a material path;
a shearing station positioned along the material path and configured to receive the material from the storage station, wherein the shearing station comprises:
a plurality of first shearing elements spaced apart from one another across the material path, wherein the first shearing elements are spaced apart from one another forming a plurality of gaps between adjacent shearing elements;
wherein each first shearing element is a rotary element having a first circumferential shearing surface, a second circumferential shearing surface and a circumferential support surface extending between the first circumferential shearing surface and the second circumferential shearing surface;
a plurality of second shearing elements spaced apart from one another across the material path, wherein the second shearing elements are spaced apart from one another forming a plurality of gaps between adjacent shearing elements;
wherein each second shearing element is a rotary element having a first circumferential shearing surface, a second circumferential shearing surface and a circumferential support surface extending between the first circumferential shearing surface and the second circumferential shearing surface;
wherein the first and second shearing elements mesh so that the second shearing elements extend into the gaps between adjacent first shearing elements and the first shearing elements extend into the gaps between adjacent second shearing elements;
wherein the first and second shearing elements are configured to shear the material into a plurality of elongated strips parallel with the axis of the reinforcing fibers;
a chopping station configured to receive strips of material from the shearing station, wherein the chopping station comprises a cutting element operable to cut each strip of material into a plurality of pieces, wherein the cutting element is oriented transverse the material path to cut across the axis of the reinforcing fibers in the composite material.

2. The apparatus of claim 1, wherein the shearing assembly is configured to drive the composite material along the material path between the first and second shearing elements.

3. The apparatus of claim 1, wherein the support surface of one of the first shearing elements is configured to support a width of the tape and displace the tape toward one of the gaps between two adjacent second shearing element so that the support surface of the first shearing element supports the width of the tape while a first edge of a first one of the second shearing element shears the material along a line substantially parallel to the material path and a second edge of a second one of the second shearing elements shears the material along a line substantially parallel to the material path.

4. The apparatus of claim 1, wherein the first shearing assembly comprises a plurality of first spacers spacing the first shearing elements apart from one another.

5. The apparatus of claim 4, wherein the second shearing assembly comprises a plurality of second spacers spacing the second shearing elements apart from one another.

6. The apparatus of claim 4, wherein the first shearing elements are substantially the same width as the second spacers.

7. The apparatus of claim 6, wherein the second shearing elements are substantially the same width as the first spacers.

8. The apparatus of claim 1, wherein the first shearing elements are rotatable elements mounted on a first shaft and the second shearing elements are rotatable elements mounted on a second shaft parallel with the first shaft.

9. The apparatus of claim 1, comprising a first comb extending into the spaces between each of the first shearing elements, wherein the first comb is configured to separate material from the first and second shearing assemblies after the first and second shearing assemblies shear the material.

10. The apparatus of claim 9, comprising a second comb spaced apart from the first comb wherein the second comb extends into the spaces between each of the second shearing elements, wherein the second comb is configured to separate material from the first and second shearing assemblies after the first and second shearing assemblies shear the material.

11. The apparatus of claim 1, wherein each of the plurality of first shearing elements comprises a rotatable disk.

12. The assembly of claim 1, wherein the first and second shearing assemblies are configured to shear the material into a plurality of strips wherein each strip has a width and each of the first and second shearing elements is configured so that each of the first and shearing elements has a width that is substantially the same as the width of each strip sheared from the material.

13. The apparatus of claim 1, wherein the chopping station comprises a rotatable cutting head having a plurality of cutting elements spaced apart from one another, wherein each cutting elements extends across the width of the material path.

14. The apparatus of claim 13, comprising a rotary element having a plurality of circumferentially spaced apart openings wherein each opening is configured to receive a cutting element of the cutting head.

15. A method for producing pieces of composite material from sheets of composite material, comprising the steps of:
providing a sheet of composite material having reinforcing fibers;
feeding the sheet into a shearing station having a plurality of upper shearing elements and a plurality of lower shearing elements that mesh with the upper shearing elements;
shearing the sheet into a plurality of strips, wherein the step of shearing comprises the step of:
forcing part of the sheet upwardly into engagement with shearing edges of the upper shearing elements;
forcing part of the sheet downwardly into engagement with shearing edge of the lower shearing elements;
feeding the plurality of strips from the shearing station to a chopping station; and
chopping each of the plurality of strips into a plurality of pieces.

16. The method of claim 15, wherein the step of displacing the sheet upwardly and displacing the sheet downwardly comprises rotating the upper shearing elements and rotating the lower shearing elements.

17. The method of claim 15, wherein the step of providing a sheet of composite material comprises providing a sheet of composite material having reinforcing fibers in which the fibers are aligned and wherein the step of shearing the sheet comprises shearing the sheet along a direction parallel to the fibers of the sheet.

18. The method of claim 17, wherein the step of chopping comprises the step of chopping the strips along a direction that is transverse the reinforcing fibers in the strips.

19. The method of claim 15, comprising the steps of:
positioning the upper shearing elements so that the upper shearing elements are spaced apart from one another forming upper gaps between adjacent upper shearing elements
positioning the lower shearing elements so that the lower shearing elements are spaced apart from one another forming lower gaps between adjacent lower shearing;
wherein the step of forcing part of the sheet upwardly comprises forcing part of the sheeting into the upper gaps and the step of forcing part of the sheet downwardly comprises forcing part of the sheet into the lower gaps.

20. The method of claim 15, wherein the step of chopping comprises shearing the plurality of strips to produce a plurality of pieces of uniform length.
